(19) United States
(12) Patent Application Publication
(10) Pub. No.: US 2025/0269700 A1
(43) Pub. Date: Aug. 28, 2025

(54) MODULE FOR MANAGING FLUIDS FOR A VEHICLE, IN PARTICULAR A MOTOR VEHICLE

(71) Applicant: VALEO SYSTEMES THERMIQUES, Le Mesnil-Saint-Denis (FR)

(72) Inventors: Thomas Blaette, Bad Rodach (DE); Andreas Fiene, Bad Rodach (DE); Lohith Sriram Pavan Thota, Chennai (IN)

(73) Assignee: VALEO SYSTEMES THERMIQUES, Le Mesnil-Saint-Denis (FR)

(21) Appl. No.: 18/858,912

(22) PCT Filed: Mar. 24, 2023
(86) PCT No.: PCT/EP2023/057741

§ 371 Date: Oct. 22, 2024

(30) Foreign Application Priority Data
Apr. 22, 2022 (FR) 2203785

(51) Int. Cl. B60H 1/32; B60H 1/00; F28D 9/00

(52) U.S. Cl. CPC B60H 1/3229; B60H 1/00485; F28D 9/0037

(57) ABSTRACT

A module for managing fluids for a vehicle is disclosed. The module includes a support having a first face and a second face, and at least one channel for the circuit of a refrigerant. The first face is opposite the second face. The first face of the support supports at least a first heat exchanger, and the second face of the support supports at least one valve.

The invention relates to a fluid management module for a vehicle, in particular a car.

Motor vehicles, in particular electric vehicles, are equipped with thermal management systems such as cooling and/or heating circuits in order to provide comfort functions for the users of this vehicle and necessary control over the temperature of components of the motor vehicle, such as, for example, batteries. Such circuits often make use of a refrigerant loop and a loop for heat transfer liquid that exchanges heat with the refrigerant.

Cooling and/or heating circuits are notably made up of thermal management components, such as pumps, valves, heat exchangers, as well as components used for temperature regulation. Components, such as ducts, are also provided that guide a fluid and fluidically connect the thermal management components to one another.

The development of electric vehicles has increased the need for optimized air conditioning and/or heat pump systems with simplified and economical manufacturing methods, while creating demand for more compact systems.

The invention aims to propose a solution to improve the situation.

In this regard, it proposes a fluid management module for a vehicle, in particular a car, comprising:
a support having a first face and a second face, the first face being opposite the second face, and
at least one channel for the circuit of a refrigerant,
   characterized in that the first face of the support supports at least a first heat exchanger and the second face of the support supports at least one valve.

Thus, such a support for a fluid management module offers an optimized layout of the components with which this module is equipped. This results in a more compact fluid management module.

The fluid management module according to the invention may further comprise at least one of the following features, alone or in combination:
the support is made up of at least a first refrigerant circulation zone intended for the circulation of the refrigerant at high pressure and a second refrigerant circulation zone intended at least for the circulation of the refrigerant at high pressure and/or at low pressure,
the support is a refrigerant circulation unit,
the support is made up of two plates secured to one another,
the channels for the circuit of a refrigerant are formed by at least one deformation of one of the two plates,
the support incorporates the channels for the circuit of a refrigerant,
the support comprises at least a first plate, referred to as a transfer plate, shaped to form at least one channel or corrugation for the circulation of the fluid,
the support comprises at least a second plate, referred to as a support plate, configured to provide the interface between the support and elements secured to the support,
the support plate is flat so as to be in contact with a part of the elements secured to the support,
the flat support plate partially defines the ducts for the refrigerant,
the support is composed of a flat plate on which ducts for the refrigerant are attached and secured,
the support comprises at least a first channel intended for the circulation of the refrigerant at high pressure,
a first channel intended for the circulation of the refrigerant at high pressure has a substantially Y shape, with a main branch and two offshoots referred to as the first and second offshoots,
at least one valve support block is inserted on an offshoot of the first channel intended for the circulation of the refrigerant at high pressure,
two valve support blocks are each inserted on an offshoot of the first channel intended for the circulation of the refrigerant at high pressure,
the valve support blocks are each capable of receiving a valve, in particular a shut-off valve,
the main branch of the first channel is intended to ensure communication between a first flange, fluidically connected to a compressor, and the first and second offshoots,
the second offshoot is intended to ensure communication between the main branch and a second flange, fluidically connected to an internal condenser,
the support also comprises at least a second channel intended for the circulation of the refrigerant at high pressure,
the support comprises four second channels intended for the circulation of the refrigerant at high pressure,
one of the second channels is intended to ensure communication between a third flange, fluidically connected to a bottle, and another heat exchanger,
one of the second channels is intended to ensure communication between a heat exchanger and a fourth flange, fluidically connected to the bottle,
one of the second channels is intended to ensure communication between a heat exchanger and a valve, preferably an expansion valve,
one of the second channels is intended to ensure communication between a heat exchanger and a valve, preferably an expansion valve,
the support also comprises at least a third channel intended for the circulation of the refrigerant at low pressure,
the support comprises five third channels intended for the circulation of the refrigerant at low pressure, one of the third channels is intended to ensure communication between a fifth flange, fluidically connected to an evaporator, and a heat exchanger,
one of the third channels is intended to ensure communication between a heat exchanger and a sixth flange fluidically connected to the compressor,
one of the third channels is intended to ensure communication between yet another heat exchanger and a heat exchanger,
one of the third channels is intended to ensure communication between an expansion valve and a heat exchanger,
one of the third channels is intended to ensure communication between an expansion valve and a seventh flange fluidically connected to the evaporator,
the at least first channel intended for the circulation of the refrigerant at high pressure is arranged in the first refrigerant circulation zone intended for the circulation of the refrigerant at high pressure, while the at least third channel intended for the circulation of the refrigerant at low pressure is arranged in a second refrigerant circulation zone intended for the circulation of the refrigerant at low pressure,
the first circulation zone is separate from the second refrigerant circulation zone,
the first circulation zone may be thermally insulated from the second circulation zone,
the first refrigerant circulation zone extends substantially in a first plane and the second refrigerant circulation zone extends substantially in a second plane and the first plane of the first refrigerant circulation zone and the second plane of the second refrigerant circulation zone are different,
the first plane of the first refrigerant circulation zone and the second plane of the second refrigerant circulation zone are parallel planes,
the first refrigerant circulation zone and the second refrigerant circulation zone are connected by a first common edge,
the first common edge comprises openings,
the support comprises a third zone capable of receiving at least part of a compressor, the third zone being separate from the first refrigerant circulation zone and from the second refrigerant circulation zone,
the third zone extends substantially in a third plane, the third plane being different to the first plane of the first refrigerant circulation zone and to the second plane of the second refrigerant circulation zone,
the first plane of the first refrigerant circulation zone, the second plane of the second refrigerant circulation zone and the third plane of the third zone are parallel planes,
the third zone and the second refrigerant circulation zone are connected by a second common edge,
the support further comprises a first opening capable of receiving at least part of an expansion valve,
the first opening receives at least part of two bodies of two expansion valves that are separate from one another,
the support comprises a second opening extending at least over the third zone capable of receiving at least part of a compressor,
the second opening also extends over the edge common to the third zone and the second refrigerant circulation zone,
the first opening comprises a step defining a first level and a second level,
the first opening is capable of receiving at least part of a first and a second expansion valve,
each of the first and second levels is capable of receiving a first or a second expansion valve,
the first common edge extends along the first opening, the first insertion block allows the integration of the fluid distribution and temperature sensor functions into the fluid management module,
the first insertion block allows insertion of the first expansion valve in a direction parallel to the plane of the first refrigerant circulation zone,
the shut-off valve is secured to the support via a valve support block common to several valves and/or an individual support block specific to each valve,
the shut-off valve is placed in fluidic communication with the first channel intended for the circulation of the refrigerant at high pressure via, preferably, the valve support block,
a temperature sensor is provided at the first channel intended for the circulation of the refrigerant at high pressure,
the temperature sensor is arranged on one of the two offshoots of the first channel intended for the circulation of the refrigerant at high pressure,
a heat exchanger of water condenser type,
the bottle is a desiccant bottle, configured to contain the refrigerant at high pressure and to capture the moisture from the refrigerant that passes through it,
an internal heat exchanger, said internal heat exchanger making it possible to transfer heat energy between a low pressure portion of the refrigerant circuit and a high pressure portion of said refrigerant circuit,
expansion valves may be an electronic expansion valve, or EXV, a thermostatic expansion valve, or TXV, or a calibrated orifice,
a heat exchanger of water cooler type,
three heat exchangers are fluidically connected to the first, second and third channels via flanges,
the module further comprises a first expansion valve, the first level comprising a first insertion block for the first expansion valve,
the first insertion block is machined in such a way as to allow the insertion of the first expansion valve in a direction parallel to a plane of extension of the support,
the first insertion block is also machined to accommodate a second temperature sensor,
an axis of longitudinal extension of an expansion valve is parallel to the plane of the first refrigerant circulation zone,
the module further comprises a second expansion valve and the second level comprises a second insertion block for the second expansion valve,
the second expansion valve is connected to a heat exchanger, preferably a water cooler, and arranged on the support and facing the second expansion valve,
the second insertion block allows the insertion of the second expansion valve in a direction parallel to a plane of extension of the support,
the second insertion block is machined in such a way as to allow the insertion of the second expansion valve in a direction parallel to the plane of the first refrigerant circulation zone,
the axis of longitudinal extension of the second expansion valve is parallel to the plane of the first refrigerant circulation zone,
the fluid management module for a vehicle, in particular a car, comprises a support having a first face and a second face, the first face being opposite the second face, and at least one channel for the circuit of a refrigerant, the first face of the support supports at least a first heat exchanger and the second face of the support supports at least one valve, the first face of the support supports a second heat exchanger,
the first face of the support supports a third heat exchanger,
the second heat exchanger is arranged between the first heat exchanger and the third heat exchanger,
the first heat exchanger is an internal exchanger and is arranged at a distance from the third heat exchanger of water condenser type,
the first heat exchanger, the second heat exchanger and the third heat exchanger each have a length and a width, the length of each of the first heat exchanger, second heat exchanger and third heat exchanger defining a direction of longitudinal extension and the directions of longitudinal extension of the second heat exchanger and the third heat exchanger are parallel and the direction of longitudinal extension of the first heat exchanger is perpendicular to the directions of longitudinal extension of the second heat exchanger and the third heat exchanger,
the first expansion valve is arranged in the vicinity of the second heat exchanger of water cooler type,
the first heat exchanger is arranged in a first refrigerant circulation zone of the support intended for the circulation of the refrigerant at high pressure, and the second heat exchanger and the third heat exchanger are arranged in a second refrigerant circulation zone of the support intended for the circulation of the refrigerant at high pressure and/or for the circulation of the refrigerant at low pressure,
the second face of the support further comprises a compressor,
the compressor is secured to the second face of the support by any means, such as screws,
vibration absorption devices placed between the support and the compressor,
the second face of the support further comprises a bottle,
the compressor and the bottle each have a direction of longitudinal extension respectively and the direction of longitudinal extension of the compressor is perpendicular to the direction of longitudinal extension of the bottle,
the module comprises two shut-off valves, preferably arranged on valve support blocks,
the second face of the support further comprises at least one temperature sensor,
a first temperature sensor is arranged in the vicinity of at least one shut-off valve,
a second temperature sensor is arranged in the vicinity of the first expansion valve,
the second temperature sensor is inserted in the first insertion block for the first expansion valve,
the first insertion block for the first expansion valve also incorporates the temperature sensor function,
the shut-off valve or valves and the temperature sensor or sensors have parallel directions of longitudinal extension and the directions of longitudinal extension of the first and second shut-off valves and of the first and second temperature sensors are perpendicular to the axes of longitudinal extension of the first expansion valve and of the second expansion valve, at least one shut-off valve is arranged in a first refrigerant circulation zone of the support intended for the circulation of the refrigerant at high pressure,
at least one temperature sensor is arranged in a second refrigerant circulation zone of the support intended for the circulation of the refrigerant at high pressure and/or for the circulation of the refrigerant at low pressure,

Further advantages and features of the present invention will become more clearly apparent from reading the following description, given by way of non-limiting illustration, and the appended drawings, in which:

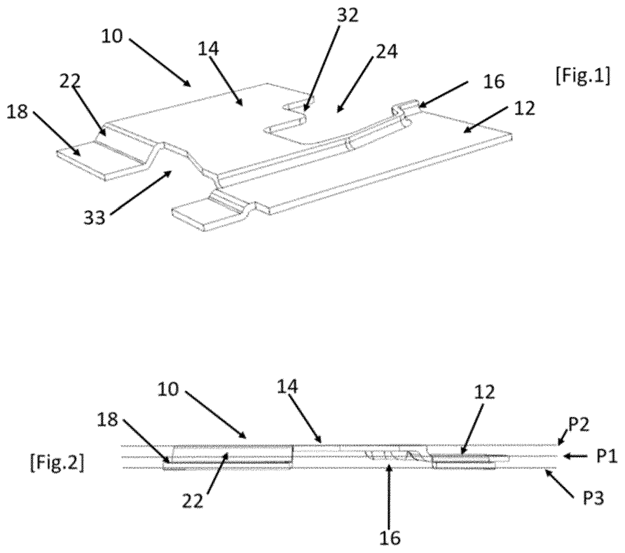

FIG. 1 is a simplified perspective view of a support of the fluid management module for a vehicle according to the invention, in which support the circulation channels have not been shown.

FIG. 2 is a side view of the support for a fluid management module of FIG. 1.

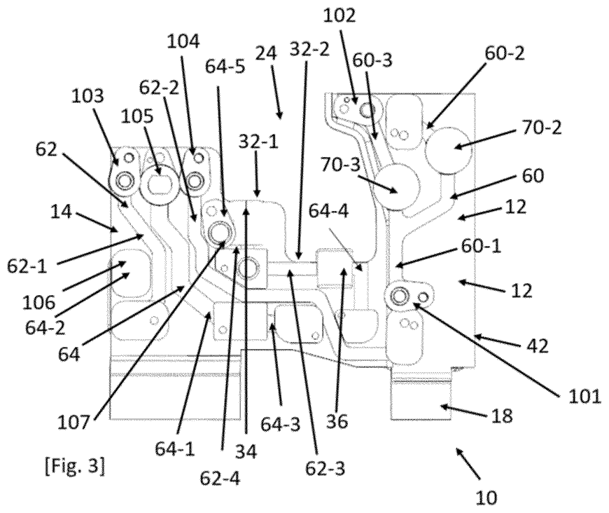

FIG. 3 is a simplified top view of a second face of the support of the fluid management module according to the invention; the second face showing the circulation channels and part of the elements arranged on this second face.

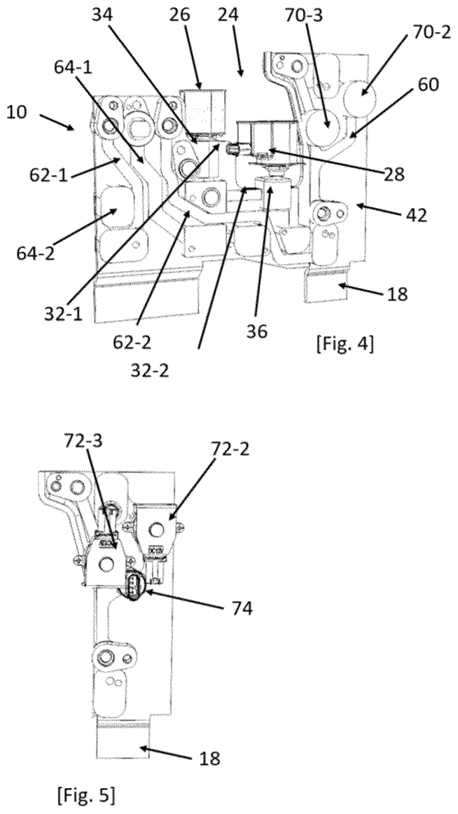

FIG. 4 is a simplified perspective view of the second face of the support of the fluid management module according to the invention; the second face showing the circulation channels and part of the elements arranged on this second face.

FIG. 5 is a simplified top view of a part of the second face of the support of the fluid management module according to the invention; in particular a first refrigerant circulation zone intended for the circulation of the refrigerant at high pressure, this first zone having the circulation channels and part of the elements arranged in this first zone.

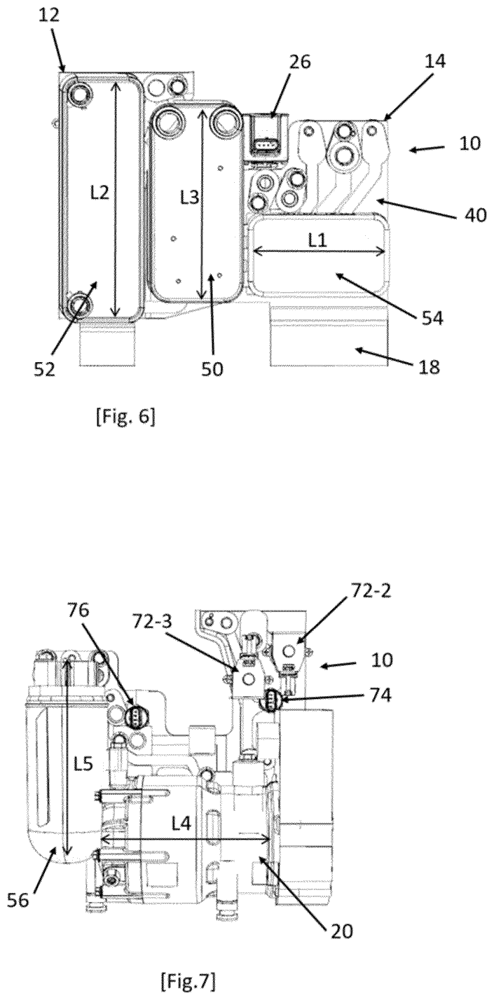

FIG. 6 is a bottom view of a first face of the support of the fluid management module according to the invention.

FIG. 7 is a top view of the second face of the support of the fluid management module according to the invention.

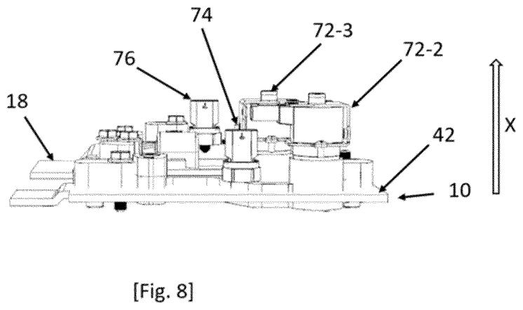

FIG. 8 is a simplified side view of the second face of the support of the fluid management module according to the invention; the second face showing the circulation channels and part of the elements arranged on this second face.

A fluid management module for a vehicle, in particular a car, comprises a support 10 comprising at least two channels 60 and 64 for the circuit of a refrigerant.

In this case, the support 10 is made up of at least a first refrigerant circulation zone 12 intended for the circulation of the refrigerant at high pressure and a second refrigerant circulation zone 14 intended at least for the circulation of the refrigerant at low pressure.

The refrigerant used by the refrigerant circuit is in this case a chemical fluid such as R1234yf. Other refrigerants could be used, such as R134a or R290 for example.

“Refrigerant at high pressure” means a refrigerant at a pressure in the region of 20 bar, and “refrigerant at low pressure” at a pressure of 3 bar.

In a particular embodiment shown notably in FIGS. 3 and 4, the support 10 is made up of at least a first refrigerant circulation zone 12 intended for the circulation of the refrigerant at high pressure and a second refrigerant circulation zone 14 intended at least for the circulation of the refrigerant at high pressure and/or at low pressure.

This support 10 is also referred to as the central platform (or hub). The support 10 is intended to form part of a thermal management system of a car in which the refrigerant circulates, in particular in an air conditioning and/or heat pump circuit.

In other words, the support 10 is a refrigerant circulation unit.

According to an embodiment, the support 10 is made up of two plates secured to one another. In such a case, the channels for the circuit of a refrigerant are formed by at least one deformation of one of the two plates.

In other words, and in this particular embodiment, the support 10 incorporates the channels for the circuit of a refrigerant.

According to this embodiment, the plates forming the support 10 each comprise one or more flat regions between the channels 60, 64.

Again according to this embodiment, the thickness of the plates forming the support is substantially uniform both in the flat regions and at the channels 60, 64.

According to a particular embodiment that has not been shown, the support 10 comprises at least a first plate, referred to as a transfer plate, shaped to form at least one channel or corrugation for the circulation of the fluid. In other words, the curvatures of the transfer plate constitute passages that form the channels.

Still in this particular embodiment that has not been shown, the support 10 comprises at least a second plate, referred to as a support plate. The support plate is configured to provide the interface between the support 10 and elements secured to the support 10.

The support plate may be flat so as to be in contact with a part of the elements secured to the support 10.

In other words, in this embodiment, the flat support plate partially defines the ducts for the refrigerant.

According to another embodiment, the support 10 is composed of a flat plate on which ducts for the refrigerant are attached and secured.

In the embodiment shown in FIG. 3, the support 10 comprises at least a first channel 60 intended for the circulation of the refrigerant at high pressure.

The first channel 60 intended for the circulation of the refrigerant at high pressure has, in the embodiment illustrated here, a substantially Y shape, with a main branch 60-1 and two offshoots referred to as the first (60-2) and second (60-3) offshoots.

In a particular embodiment, at least one valve support block is inserted on an offshoot of the first channel 60 intended for the circulation of the refrigerant at high pressure.

In the particular embodiment illustrated in FIGS. 3 and 4, two valve support blocks 70-2 and 70-3 are each inserted on an offshoot 60-2 or 60-3 of the first channel 60 intended for the circulation of the refrigerant at high pressure.

In this case, the valve support blocks 70-2 and 70-3 are each capable of receiving a valve, in particular a shut-off valve 72-2 or 72-3, shown in FIG. 5.

According to alternative embodiments that have not been shown, the support 10 comprises valves such as progressive valves, EXVs (electronic expansion valves) or TXVs (thermostatic expansion valves). These valves will preferably be secured to the support 10 via a valve support block common to several valves and/or an individual support block specific to each valve.

Thus, the support 10 comprises at least one valve support block 70-2 or 70-3 which can be considered to be a block for distributing the refrigerant in the support 10.

In other words, a shut-off valve 72-2 or 72-3 is placed in fluidic communication with the first channel 60 intended for the circulation of the refrigerant at high pressure via, in this particular embodiment, the valve support block 70-2 or 70-3.

More particularly, in this case, fluidic communication is achieved at each respective offshoot 60-2 or 60-3 of the first channel 60 intended for the circulation of the refrigerant at high pressure.

A temperature sensor 74 (shown for example in FIG. 5) is provided at the first channel 60 intended for the circulation of the refrigerant at high pressure.

In this embodiment illustrated here, the temperature sensor 74 is arranged on one of the two offshoots of the first channel 60 intended for the circulation of the refrigerant at high pressure (in this case the second offshoot 60-2).

More particularly, the temperature sensor 74 is arranged in the vicinity of the junction between the main branch 60-1 and the two offshoots 60-2 and 60-3 of the first channel 60 intended for the circulation of the refrigerant at high pressure.

As stated above, the first channel 60 is intended for the circulation of the refrigerant at high pressure.

In this embodiment, the main branch 60-1 of the first channel 60 is intended to ensure communication between a first flange 101, fluidically connected to a compressor 20, and the first (60-2) and second (60-3) offshoots.

The first offshoot 60-2 is intended to ensure communication between the main branch 60-1 and a heat exchanger, hereinafter referred to as the third heat exchanger.

According to this embodiment, the third heat exchanger 52 is of water condenser type. This exchanger is configured to perform an exchange of heat energy between the refrigerant at high pressure and a heat transfer liquid.

The second offshoot 60-3 is intended to ensure communication between the main branch 60-1 and a second flange 102, fluidically connected to an internal condenser, not shown here. This internal condenser is a thermal regulation device for the car interior, located for example in said car interior. Said internal condenser is intended to heat a flow of air passing through it.

The support 10 also comprises at least a second channel 62 intended for the circulation of the refrigerant at high pressure.

In the particular embodiment shown in FIG. 3, the support 10 comprises four second channels 62-1, 62-2, 62-3, 62-4 intended for the circulation of the refrigerant at high pressure.

In this same embodiment, one of the second channels, hereinafter referenced 62-1, is intended to ensure communication between a third flange 103, fluidically connected to a bottle 56, and another heat exchanger, hereinafter referred to as the first heat exchanger 54.

According to this embodiment, the bottle 56 is a desiccant bottle, configured to contain the refrigerant at high pressure and to capture the moisture from the refrigerant that passes through it.

According to another embodiment, not shown, the bottle 56 may be an accumulator. According to this other embodiment, the bottle 56, or accumulator, would be placed on a low pressure portion of the circuit.

According to the embodiment illustrated in FIG. 3, the first heat exchanger 54 is an internal heat exchanger, said internal heat exchanger making it possible to transfer heat energy between a low pressure portion of the refrigerant circuit and a high pressure portion of said refrigerant circuit. Such an exchange of heat energy makes it possible to optimize the thermodynamic properties of the refrigerant circuit.

In this same embodiment, one of the second channels, hereinafter referenced 62-2, is intended to ensure communication between the third heat exchanger 52 and a fourth flange 104, fluidically connected to the bottle 56.

Still in this same embodiment illustrated here, one of the second channels, hereinafter referenced 62-3, is intended to ensure communication between the first heat exchanger 54 and a valve, preferably an expansion valve. In the remainder of the description, this expansion valve will be referred to as the second expansion valve 28.

Still in this same embodiment illustrated here, one of the second channels, hereinafter referenced 62-4, is intended to ensure communication between the first heat exchanger 54 and another valve, preferably an expansion valve. In the remainder of the description, this expansion valve will be referred to as the first expansion valve 26.

Each of the expansion valves 26, 28 may be an electronic expansion valve, or EXV, a thermostatic expansion valve, or TXV, or a calibrated orifice. In the case of an electronic expansion valve, the flow area allowing the refrigerant to pass through can be adjusted continuously between a closed position and a fully open position. To this end, the electronic controller controls an electric motor that moves a movable shut-off device controlling the flow area available to the refrigerant.

The support 10 also comprises at least a third channel 64 intended for the circulation of the refrigerant at low pressure.

In the particular embodiment shown in FIG. 3, the support 10 comprises five third channels 64-1, 64-2, 64-3, 64-4 and 64-5 intended for the circulation of the refrigerant at low pressure.

In this same embodiment, one of the third channels, hereinafter referenced 64-1, is intended to ensure communication between a fifth flange 105, fluidically connected to an evaporator, not shown, and the first heat exchanger 54. This evaporator is a thermal regulation device for the car interior, located for example in said car interior. Said evaporator is intended to cool a flow of air passing through it.

Still in this same embodiment illustrated here, one of the third channels, hereinafter referenced 64-2, is intended to ensure communication between the first heat exchanger 54 and a sixth flange 106, fluidically connected to the compressor 20.

In this same embodiment, one of the third channels, hereinafter referenced 64-3, is intended to ensure communication between yet another heat exchanger (hereinafter referred to as the second heat exchanger 50) and the first heat exchanger 54.

According to this embodiment, the second heat exchanger 50 is of water cooler (or chiller) type. This exchanger is configured to perform an exchange of heat energy between the refrigerant at low pressure and a heat transfer liquid.

Still in this same embodiment, one of the third channels, hereinafter referenced 64-4, is intended to ensure communication between the second expansion valve 28 and the second heat exchanger 50.

In this same embodiment, one of the third channels, hereinafter referenced 64-5, is intended to ensure communication between the first expansion valve 26 and the seventh flange 107, fluidically connected to the evaporator.

The two expansion valves 26, 28 make it possible to control the supply of refrigerant to the evaporator and the second heat exchanger 50. Thus, depending on the position of the expansion valves 26, 28, the evaporator and/or the second heat exchanger 50 can be supplied with refrigerant.

According to an embodiment, the first (54), second (50) and third (52) heat exchangers are fluidically connected to the first, second and third channels 60, 62, 64 via flanges. More specifically, the first heat exchanger 54 is connected by means of an eighth, ninth, tenth and eleventh flange, respectively to the second channel 62-1, to the second channels 62-3 and 62-4, to the third channel 64-2 and to the third channels 64-1 and 64-3, the second heat exchanger 50 is connected by means of a twelfth and thirteenth flange, respectively to the third channel 64-3 and to the third channel 64-4, and the third heat exchanger 52 is connected by means of a fourteenth flange and a fifteenth flange respectively to the first offshoot 60-2 of the first channel 60 and to the second channel 62-2.

In the embodiment illustrated in particular in FIG. 3 and subsequent figures, the at least first channel 60 intended for the circulation of the refrigerant at high pressure is arranged in the first refrigerant circulation zone 12 intended for the circulation of the refrigerant at high pressure, while the at least third channel 64 intended for the circulation of the refrigerant at low pressure is arranged in a second refrigerant circulation zone 14 intended for the circulation of the refrigerant at low pressure.

In the particular example illustrated here, the first circulation zone 12 is separate from the second refrigerant circulation zone 14.

The first circulation zone 12 may be thermally insulated from the second circulation zone 14.

The first refrigerant circulation zone 12 extends substantially in a first plane P1 and the second refrigerant circulation zone 14 extends substantially in a second plane P2.

The first plane P1 of the first refrigerant circulation zone 12 and the second plane P2 of the second refrigerant circulation zone 14 are different.

In this embodiment, the first plane P1 of the first refrigerant circulation zone 12 and the second plane P2 of the second refrigerant circulation zone 14 are parallel planes.

The first refrigerant circulation zone 12 and the second refrigerant circulation zone 14 are connected by a first common edge 16.

In an embodiment that has not been shown, the first common edge 16 comprises openings.

According to the invention, the support 10 further comprises a first opening 24 capable of receiving at least part of an expansion valve 26.

In the embodiment shown here, the first opening 24 receives at least part of two bodies of two expansion valves 26 and 28 that are separate from one another.

The first expansion valve 26 is connected to the evaporator (not shown) arranged elsewhere in the car, and in particular in an air conditioning housing.

The second expansion valve 28 is connected to a second exchanger 50, preferably of water cooler type, and arranged on a face of the support 10 and facing the second expansion valve 28.

In the embodiment shown here, the first common edge 16 extends along the first opening 24. This extension performs in particular a function of mechanical reinforcement of the support 10.

The support 10 comprises a second opening 33 extending at least over the third zone 18 capable of receiving at least part of the compressor 20.

This second opening 22 can be considered to be a cutout making it possible to make the support 10 more lightweight, and making it possible to define two attachment lugs for the compressor 20.

The second opening 33 also extends over the edge 22 common to the third zone 18 and the second refrigerant circulation zone 14.

In other words, this first opening 24 makes it possible to house at least part of the body of the expansion valve 26.

In a particular embodiment, the expansion valve 26 is an electronically controlled expansion valve.

The first expansion valve 26 is connected to an evaporator (not shown) arranged elsewhere in the car, and in particular in an air conditioning housing.

The first opening 24 comprises a step 32 defining a first level 32-1 and a second level 32-2.

The first opening 24 is capable of receiving at least part of a first 26 and a second 28 expansion valve.

Each of the first and second levels 32-1 and 32-2 is capable of receiving a first or a second expansion valve 26 and 28.

The first level 32-1 comprises a first insertion block 34 for the first expansion valve 26.

In this case, the first insertion block 34 is machined in such a way as to allow the insertion of the first expansion valve 26 in a direction parallel to a plane of extension of the support 10. This saves space, making the module more compact.

According to an embodiment illustrated in FIG. 7, the first insertion block 34 is also machined to accommodate a second temperature sensor 76.

In other words, the first insertion block 34 allows the integration of the fluid distribution (via the valve, in this case the expansion valve) and temperature sensor functions into the fluid management module.

In the embodiment illustrated here, the first insertion block 34 allows insertion of the first expansion valve 26 in a direction parallel to the plane P1 of the first refrigerant circulation zone 12.

In this particular embodiment, the first expansion valve 26 has an axis of longitudinal extension. The axis of longitudinal extension of the first expansion valve 26 is parallel to the plane P1 of the first refrigerant circulation zone 12.

The second level 32-2 comprises a second insertion block 36 for the second expansion valve 28.

The second expansion valve 28 is connected to a second heat exchanger 50, preferably a heat exchanger of water cooler type, and arranged on the support 10 and facing the second expansion valve 28.

In other words, this first opening 24 makes it possible to house at least part of the body of the second expansion valve 28.

In the embodiment illustrated here, the first opening 24 makes it possible to house two expansion valves 26 and 28.

In a particular embodiment, the second expansion valve 28 is an electronically controlled expansion valve.

In this case, the second insertion block 36 allows the insertion of the second expansion valve 28 in a direction parallel to a plane of extension of the support 10. This saves space, making the module more compact.

In the embodiment illustrated here, the second insertion block 36 is machined in such a way as to allow the insertion of the second expansion valve 28 in a direction parallel to the plane P1 of the first refrigerant circulation zone 12.

In this particular embodiment, the second expansion valve 28 has an axis of longitudinal extension. The axis of longitudinal extension of the second expansion valve 28 is parallel to the plane P1 of the first refrigerant circulation zone 12.

The support 10 comprises a third zone 18 capable of receiving at least part of a compressor 20, the third zone 18 being separate from the first refrigerant circulation zone 12 and from the second refrigerant circulation zone 14.

The third zone 18 extends substantially in a third plane P3, the third plane P3 being different to the first plane P1 of the first refrigerant circulation zone 12 and to the second plane P2 of the second refrigerant circulation zone 14.

In this embodiment, the first plane P1 of the first refrigerant circulation zone 12, the second plane P2 of the second refrigerant circulation zone 14 and the third plane P3 of the third zone 18 are parallel planes.

The third zone 18 and the second refrigerant circulation zone 14 are connected by a second common edge 22.

According to the invention, the fluid management module for a vehicle, in particular a car, comprises:
the support 10 having a first face 40 and a second face 42, the first face 40 being opposite the second face 42, and,
at least one channel 60, 62 and 64 for the circuit of a refrigerant,
the first face 40 of the support 10 supports at least a first heat exchanger 54 and the second face 42 of the support 10 supports at least one valve 72-2 or 72-3.

Such a configuration saves space by arranging different elements of the fluid management module on both faces of the support 10 in an optimized manner.

In the embodiment illustrated here, the first heat exchanger 54 is an exchanger referred to as an IHX (Internal Heat Exchanger). The first heat exchanger 54 of IHX type allows heat exchange between the refrigerant circulating at high pressure and the refrigerant circulating at low pressure.

The first face 40 of the support 10 supports a second heat exchanger 50.

In the embodiment illustrated here, the second heat exchanger 50 is an exchanger of water cooler type. The second heat exchanger 50 of water cooler type allows heat exchange between the refrigerant and a heat transfer liquid, in particular, in this case, glycol water.

The first face 40 of the support 10 supports a third heat exchanger 52.

In the embodiment illustrated here, the third heat exchanger 52 is an exchanger of water condenser (or WCDS) type. The third heat exchanger 52 of water condenser type also allows heat exchange between the refrigerant and a heat transfer liquid, in particular, in this case, glycol water.

The second heat exchanger 50 is arranged between the first heat exchanger 54 and the third heat exchanger 52.

This has the technical effect of improving the efficiency of heat exchange through the module by helping to create a thermal gradient. To be specific, the refrigerant circulating in the third heat exchanger 52 of water condenser type is warmer than that circulating in the second heat exchanger 50 of water cooler type.

The first heat exchanger 54 of internal exchanger type is arranged at a distance from the third heat exchanger 52 of water condenser type 52 such that the latter does not transmit heat to the first heat exchanger 54 of internal exchanger type.

More specifically, an air gap separates the first heat exchanger 54 from the third heat exchanger 52, this air gap having the effect of thermally insulating them from one another.

The first heat exchanger 54, the second heat exchanger 50 and the third heat exchanger 52 each have a length and a width, the length of each of the first heat exchanger 54, second heat exchanger 50 and third heat exchanger 52 defining a direction of longitudinal extension L1, L2 and L3, respectively. The directions of longitudinal extension L2 and L3 of the second heat exchanger 50 and the third heat exchanger 52 are parallel. The direction of longitudinal extension L1 of the first heat exchanger 54 is perpendicular to the directions of longitudinal extension L2 and L3 of the second heat exchanger 50 and the third heat exchanger 52.

Such a distribution also contributes to improving the efficiency of heat exchange through the module by helping to create a thermal gradient.

In the embodiment illustrated here, the first heat exchanger 54 comprises a notch, or cutout, extending on the support 10 side, perpendicular to the direction of longitudinal extension L1 of said first heat exchanger 54. This cutout has the effect of creating a space allowing the passage of at least one of the channels 60, 62, 64 of the fluid management module.

In the embodiment illustrated here, note that the first expansion valve 26 is arranged in the vicinity of the second heat exchanger 50 of water cooler type.

As stated above, the first expansion valve 26 has an axis of longitudinal extension. The axis of longitudinal extension of the first expansion valve 26 is parallel to the plane P1 of the first refrigerant circulation zone 12.

Moreover, in this case, the axis of longitudinal extension of the first expansion valve 26 is parallel to the directions of longitudinal extension L2 and L3 of the second heat exchanger 50 and the third heat exchanger 52.

This arrangement also makes the fluid management module more compact.

The first heat exchanger 54 is arranged in a first refrigerant circulation zone 12 of the support 10 intended for the circulation of the refrigerant at high pressure.

The second heat exchanger 50 and the third heat exchanger 52 are arranged in a second refrigerant circulation zone 14 of the support 10 intended for the circulation of the refrigerant at high pressure and/or for the circulation of the refrigerant at low pressure.

The second face 42 of the support 10 further comprises a compressor 20.

In this embodiment, the compressor 20 is secured to the second face 42 of the support 10 by any means, such as screws.

It is also possible to provide vibration absorption devices placed between the support 10 and the compressor 20.

Such absorption devices, or other mechanical decoupling elements, could also be interposed between the support 10 and the structure of the vehicle.

The second face 42 of the support 10 further comprises a bottle 56.

In other words, in this embodiment, the bottle 56 is secured to the second face 42 of the support 10.

The bottle 56 is a desiccant bottle, with the function of separating the liquid refrigerant and the gaseous refrigerant, at high pressure, allowing storage and capturing the moisture from the refrigerant that passes through it.

According to another embodiment, the bottle 56 could be an accumulator. According to this other embodiment, the bottle 56, or accumulator, would be placed on a low pressure portion of the circuit.

The bottle 56 could be fitted with a refrigerant loading valve.

The compressor 20 and the bottle 56 each have a direction of longitudinal extension L4 and L5, respectively. The direction of longitudinal extension L4 of the compressor is perpendicular to the direction of longitudinal extension L5 of the bottle 56.

The directions of longitudinal extension L4 and L5, respectively of the compressor 20 and of the bottle 56, extend parallel to the first, second and third planes P1, P2 and P3.

These arrangements of the compressor 20 and the bottle 56 make it possible to make the fluid management module more compact.

The second face 42 of the support 10 comprises at least one valve 73-2 or 72-3.

In the embodiment illustrated in FIG. 7, two valves are provided, in this case shut-off valves 72-1 and 72-2. In particular, these shut-off valves 72-2 and 72-3 are provided arranged on valve support blocks 70-2 and 70-3 (not shown in FIG. 7).

The second face 42 of the support 10 comprises at least one temperature sensor 74 or 76.

In the embodiment illustrated in FIG. 7, a first temperature sensor 74 is arranged in the vicinity of at least one valve, in this case shut-off valve 72-2 or 72-4.

By way of example, it is possible to provide a second temperature sensor 76 arranged in this case in the vicinity of the first expansion valve 26.

More particularly, the second temperature sensor 76 is inserted in the first insertion block 34 for the first expansion valve 26.

In other words, the first insertion block 34 for the first expansion valve 26 also incorporates the temperature sensor function. To this end, according to a particular embodiment, the first insertion block 34 for the first expansion valve 26 is machined to receive the second temperature sensor 76.

The first and second shut-off valves 72-2 and 72-3 and the first and second temperature sensors 74 and 76 all have a direction of longitudinal extension.

The shut-off valve 72-2 or 72-3 and the temperature sensor 74 or 76 have parallel directions of longitudinal extension.

In this embodiment, illustrated in particular in FIG. 8, the directions of longitudinal extension of the first and second shut-off valves 72-2 and 72-3 and the first and second temperature sensors 74 and 76 are all parallel to one another and parallel to the direction X.

Note that in this particular embodiment, the directions of longitudinal extension of the first and second shut-off valves 72-2 and 72-3 and of the first and second temperature sensors 74 and 76 are perpendicular to the axes of longitudinal extension of the first expansion valve 26 and of the second expansion valve 28.

At least one shut-off valve 72-2 or 72-3 is arranged in a first refrigerant circulation zone 12 of the support 10 intended for the circulation of the refrigerant at high pressure.

At least one temperature sensor 76 is arranged in a second refrigerant circulation zone 14 of the support 10 intended for the circulation of the refrigerant at high pressure and/or for the circulation of the refrigerant at low pressure.

The invention is not limited to the embodiments presented, and other embodiments will become apparent to a person skilled in the art. It is in particular possible to use any other attachment means as long as they are reversible attachment means.

1. A fluid management module for a vehicle, in particular a car, comprising:
a support having a first face and a second face, the first face being opposite the second face; and
at least one channel for the circuit of a refrigerant,
wherein the first face of the support supports at least a first heat exchanger and the second face of the support supports at least one valve, wherein the first face of the support supports a second heat exchanger.

2. (canceled)

3. The fluid management module as claimed in claim 1, wherein the first face of the support supports a third heat exchanger.

4. The fluid management module as claimed in claim 3, wherein the second heat exchanger is arranged between the first heat exchanger and the third heat exchanger.

5. The fluid management module as claimed in claim 4,
wherein the first heat exchanger, the second heat exchanger and the third heat exchanger each have a length and a width,
wherein the length of each of the first heat exchanger, second heat exchanger and third heat exchanger defining a direction of longitudinal extension respectively,
wherein the directions of longitudinal extension of the second heat exchanger and the third heat exchanger are parallel, and
wherein the direction of longitudinal extension of the first heat exchanger is perpendicular to the directions of longitudinal extension of the second heat exchanger and the third heat exchanger.

6. The fluid management module as claimed in claim 3,
wherein the first heat exchanger is arranged in a first refrigerant circulation zone of the support, for the circulation of the refrigerant at high pressure, and
wherein the second heat exchanger and the third heat exchanger are arranged in a second refrigerant circulation zone of the support, for the circulation of the refrigerant at high pressure and/or the circulation of the refrigerant at low pressure.

7. The fluid management module as claimed in claim 6,
wherein the first refrigerant circulation zone extends substantially in a first plane and the second refrigerant circulation zone extends substantially in a second plane, and
wherein the first plane of the first refrigerant circulation zone and the second plane of the second refrigerant circulation zone are different.

8. The fluid management module as claimed in claim 7, wherein the first refrigerant circulation zone and the second refrigerant circulation zone are connected by a first common edge.

9. The fluid management module for a vehicle as claimed in claim 1, wherein the second face of the support further comprises a compressor.

10. The fluid management module for a vehicle as claimed in claim 1, wherein the second face of the support further comprises a bottle.

11. The fluid management module for a vehicle as claimed in claim 1, wherein the second face of the support comprises at least one temperature sensor.

12. The fluid management module for a vehicle as claimed in claim 11, wherein the valve and the temperature sensor have parallel directions of longitudinal extension.

13. The fluid management module as claimed in claim 11,
wherein at least one valve is arranged in a first refrigerant circulation zone of the support, for the circulation of the refrigerant at high pressure,
wherein at least one temperature sensor is arranged in a second refrigerant circulation zone of the support for the circulation of the refrigerant at high pressure and/or for the circulation of the refrigerant at low pressure.
